(19) United States
(12) Patent Application Publication
(10) Pub. No.: US 2021/0352423 A1
(43) Pub. Date: Nov. 11, 2021

(54) AUDIO DIAGNOSTICS IN A VEHICLE

(71) Applicant: Ningbo Geely Automobile Research & Development Co., Ltd., Ningbo (CN)

(72) Inventors: Tomas GUSTAFSSON, Göteborg (SE); Ajay DHAKSHANA MURTHY, Göteborg (SE)

(21) Appl. No.: 17/384,396

(22) Filed: Jul. 23, 2021

Related U.S. Application Data
(63) Continuation of application No. PCT/CN2020/074287, filed on Feb. 4, 2020.

(30) Foreign Application Priority Data
Feb. 8, 2019 (EP) 19156225.5

(51) Int. Cl. H04R 29/00

(52) U.S. Cl. CPC H04R 29/00; H04R 2499/13

(57) ABSTRACT

A method for diagnosing an audio system in a vehicle includes generating an audio signal of a particular frequency for at least one speaker in the audio system, transmitting the generated audio signal to a compare function in the audio system in response to the generating of the audio signal, outputting the generated audio signal in the at least one speaker in the audio system, receiving the outputted audio signal in at least one microphone in the audio system, transmitting the received audio signal to the compare function in the audio system in response to the receiving of the audio signal, determining by the compare function a similarity between the generated and the received audio signal, and setting a confidence level on the determined similarity based on a current operational mode of the vehicle.

### RELATED APPLICATION DATA

This application is a continuation of International Patent Application No. PCT/CN2020/074287, filed Feb. 4, 2020, which claims the benefit of European Patent Application No. 19156225.5, filed Feb. 8, 2019, the disclosures of which are incorporated herein by reference in their entireties.

### TECHNICAL FIELD

The present disclosure relates generally to the field of audio diagnostics in a vehicle. More particularly, it relates to diagnosing an audio system in a vehicle.

### BACKGROUND

A vehicle may typically comprise an audio system comprising a plurality speakers and microphones. The audio system may be subject to diagnosing wherein the speakers output a test tone in each of the speakers in sequence. Hence, current audio system diagnostics rely on a test tone being outputted in sequence by the speakers and being received by the microphones. The signal strength of the test tone needs to be clearly hearable making the diagnostics only usable at end of line, i.e. at production testing, as interference must be kept at a minimum.

The audio system diagnostics may therefore not be able to perform diagnostics when the audio system is in use by e.g. vehicle occupants as the interference caused by the vehicle occupants or the vehicle itself may result in interference and incorrect diagnostics.

Therefore, there is a need for alternative approaches to diagnosing an audio system in a vehicle.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

An object of some embodiments is to provide alternative approaches to diagnosing an audio system in a vehicle.

According to a first aspect, this is achieved by a method for diagnosing an audio system in a vehicle.

The method comprises generating an audio signal of a particular frequency for at least one speaker in the audio system, transmitting the generated audio signal to a compare function in the audio system in response to the generating of the audio signal and outputting the generated audio signal in the at least one speaker in the audio system.

The method further comprises receiving the outputted audio signal in at least one microphone in the audio system, transmitting the received audio signal to the compare function in the audio system in response to the receiving of the audio signal, determining by the compare function a similarity between the generated and the received audio signal, and setting a confidence level on the determined similarity based on a current operational mode of the vehicle.

An advantage of some embodiments is that a method for diagnosing an audio system in a vehicle is provided.

Another advantage of some embodiments is that a diagnosing method of an audio system in a vehicle, while in use by vehicle occupants, is provided.

Yet an advantage of some embodiments is that a minimum interference diagnosing method of an audio system in a vehicle, performed in runtime, is provided.

Yet another advantage of some embodiments is that individual speakers/microphones of the audio system in a vehicle may be diagnosed provided that the generated audio signal is outputted in the speakers in sequence or provided that the generated audio signals to be outputted in the speakers are speaker specific.

In some embodiments, the method further comprises determining the current operational mode of the vehicle.

In some embodiments, the generated audio signal is transmitted to the compare function after being processed and while being in the digital domain.

An advantage of some embodiments is that the digital signal of the generated audio signal provides the original audio signal without interference of which the received signal is to be compared with.

In some embodiments, the received audio signal is transmitted to the compare function after being processed and once being in the digital domain.

An advantage of some embodiments is that the digital signal of the received audio signal may be compared with the digital signal of the generated audio signal so that any differences between the generated audio signal and the received signal may be determined and thereby indicate possible interference on the received audio signal.

In some embodiments, the processing comprises sampling of the audio signal.

An advantage of some embodiments is that the sampling converts a sound wave (i.e. a continuous signal) to a sequence of samples (i.e. a discrete-time signal).

In some embodiments, the compare function determines a similarity between the generated and the received audio signal.

An advantage of some embodiments is that the similarity between the generated and the received audio signal is determined by the compare function either by correlation or any other suitable function so that any interference on the received audio signal may be detected.

In some embodiments, the audio signal is distinguished from the ambient input at least in its frequency.

An advantage of some embodiments is that the audio signal is distinguishable so that it may be subject to a comparison with the generated audio signal in the compare function.

In some embodiments, the current operational mode of the vehicle is based on an input received from at least one sensor in the vehicle.

An advantage of some embodiments is that the operational mode is determined based on sensor input in the vehicle so that the operational mode reflects the received input from the sensors.

In some embodiments, the confidence level is set to high when the input is indicative of a low impact on correlation.

An advantage of some embodiments is that a higher trust (i.e. confidence level) may be set to the correlation when there is a low impact on correlation i.e. low interference (indicated by the operational mode) so that the diagnostics may be more accurate.

In some embodiments, the confidence level is set to low when the input is indicative of a high impact on the correlation.

An advantage of some embodiments is that a lower trust (i.e. confidence level) may be set to the correlation when there is a high impact on correlation i.e. high interference (indicated by the operational mode) so that the diagnostics may be more accurate.

In some embodiments, the at least one sensor in the vehicle comprises any one of a speed detection sensor, a seat occupation sensor, and a window state sensor.

An advantage of some embodiments is that a range of interference sources may be taken into account when determining the operational mode of the vehicle and the confidence level.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is an apparatus for diagnosing an audio system in a vehicle.

The apparatus comprises a memory comprising executable instructions, one or more processors configured to communicate with the memory wherein the one or more processors are configured to cause the apparatus to generate an audio signal of a particular frequency for at least one speaker in the audio system, transmit the generated audio signal to a compare function in the audio system in response to the generating of the audio signal, and output the generated audio signal in the at least one speaker in the audio system.

The one or more processors are further configured to cause the apparatus to receive the outputted audio signal in at least one microphone in the audio system, transmit the received audio signal to the compare function in the audio system in response to the receiving of the audio signal, determine by the compare function a similarity between the generated and the received audio signal, and set a confidence level on the determined similarity based on a current operational mode of the vehicle.

An advantage of some embodiments is that an apparatus for diagnosing an audio system in a vehicle is provided.

Another advantage of some embodiments is that diagnosing of an audio system in a vehicle, while in use by vehicle occupants, is enabled.

Yet an advantage of some embodiments is that minimum interference diagnosing of an audio system in a vehicle, performed in runtime, is enabled.

Yet another advantage of some embodiments is that individual speakers/microphones of the audio system in a vehicle may be diagnosed provided that the generated audio signal is outputted in the speakers in sequence or provided that the generated audio signals to be outputted in the speakers are speaker specific.

In some embodiments, the one or more processors are configured to cause the apparatus to determine the current operational mode of the vehicle.

In some embodiments, the one or more processors are configured to cause the apparatus to perform a compare function for determining a similarity between the generated and the received audio signal.

An advantage of some embodiments is that the similarity between the generated and the received audio signal is determined by the compare function either by correlation or any other suitable function so that any interference on the received audio signal may be detected.

A fourth aspect is a vehicle comprising the apparatus according to the third aspect.

A fifth aspect is a system for diagnosing an audio system in a vehicle.

The system comprises a generating module configured to generate an audio signal of a particular frequency for at least one speaker in the audio system, a transmitting module configured to transmit the generated audio signal to a compare function in the audio system in response to the generating of the audio signal, and an outputting module configured to output the generated audio signal in the at least one speaker in the audio system.

The system further comprises a receiving module configured to receive the outputted audio signal in at least one microphone in the audio system, a transmitting module configured to transmit the received audio signal to the compare function in the audio system in response to the receiving of the audio signal, a determining module configured to determine a similarity between the generated and the received audio signal, and a setting module configured to set a confidence level on the determined similarity based on a current operational mode of the vehicle.

An advantage of some embodiments is that a system for diagnosing an audio system in a vehicle is provided.

Another advantage of some embodiments is that diagnosing of an audio system in a vehicle, while in use by vehicle occupants, is enabled.

Yet an advantage of some embodiments is that minimum interference diagnosing of an audio system in a vehicle, performed in runtime, is enabled.

Yet another advantage of some embodiments is that individual speakers/microphones of the audio system in a vehicle may be diagnosed provided that the generated audio signal is outputted in the speakers in sequence or provided that the generated audio signals to be outputted in the speakers are speaker specific.

In some embodiments, the system further comprises a determining module configured to determine the current operational mode of the vehicle.

In some embodiments, the system further comprises a compare function module configured to determine a similarity between the generated and the received audio signal.

An advantage of some embodiments is that the similarity between the generated and the received audio signal is determined by the compare function either by correlation or any other suitable function so that any interference on the received audio signal may be detected.

In some embodiments, any of the above aspects may additionally have features identical with or corresponding to any of the various features as explained above for any of the other aspects.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is flowchart illustrating example method steps according to some embodiments;

FIG. 2 is flowchart illustrating example method steps according to some embodiments;

FIG. 3 is a schematic overview illustrating an example system according to some embodiments;

FIG. 4 is a schematic block diagram illustrating an example arrangement according to some embodiments; and

FIG. 5 is a schematic drawing illustrating an example computer readable medium according to some embodiments.

### DETAILED DESCRIPTION

As already mentioned above, it should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, embodiments will be described where alternative approaches to diagnosing an audio system in a vehicle are provided.

Operational mode of a vehicle, as described herein, may comprise a mode determined based on a set of variables related to the vehicle, wherein the set of variables may comprise state of the vehicle, number of vehicle occupants, speed of the vehicle, and other vehicle activity that may generate interference in an audio system.

Confidence level, as described herein, may comprise an indication of a level of confidence on a determined similarity between audio signals in an audio system based on the operational model. Hence, when the operational mode, and corresponding interference impact, of the vehicle changes so does the confidence level.

Correlation impact, as described herein, may comprise an indication of an impact on a correlation based on the operational mode of the vehicle, wherein the impact on the correlation provides the confidence level on the correlation. Hence, the confidence levels may vary based on the correlation impact.

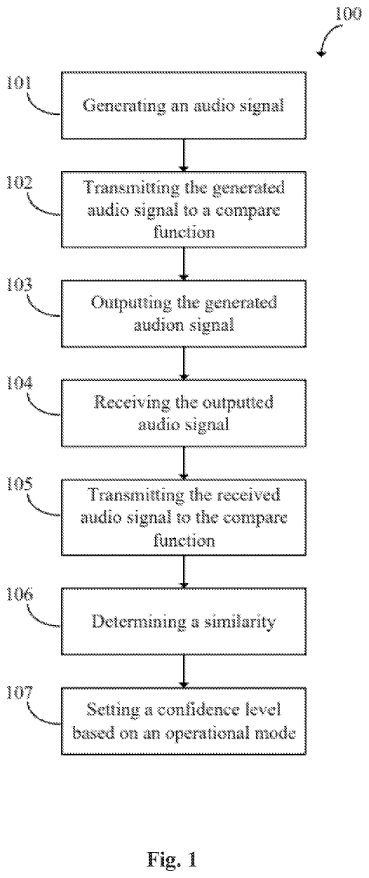

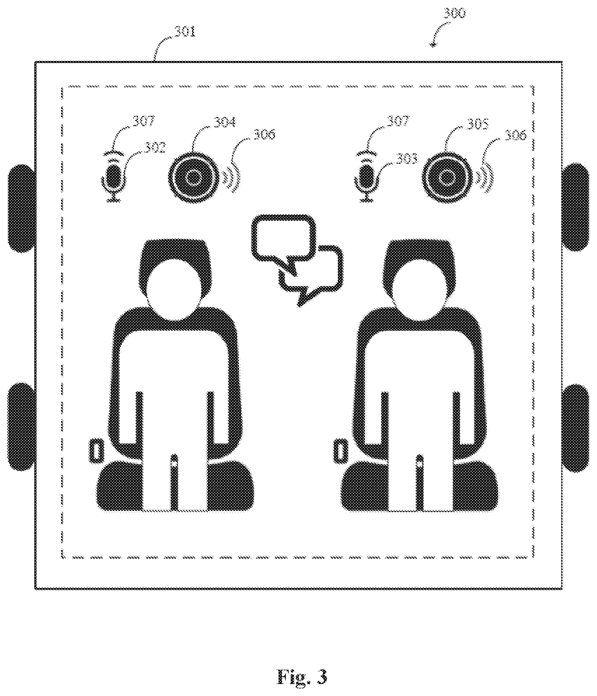

FIG. 1 is a flowchart illustrating example method steps according to some embodiments. The audio diagnostics method 100 is for diagnosing an audio system in a vehicle. Thus, the method 100 may, for example, be performed by an audio diagnostics system 300 of FIG. 3.

In step 101, an audio signal of a particular frequency for at least one speaker in the audio system is generated.

For example, the audio signal may comprise a representation of sound, typically as an electrical voltage for analog signals and a binary number for digital signals. Typically, audio signals have frequencies in the audio frequency range of roughly 20 to 20000 Hz. Generating an audio signal may comprise the audio signal being synthesized directly, or may be originated at a transducer such as a microphone and speakers convert the electrical audio signal into sound.

In step 102, the generated audio signal is transmitted to a compare function in the audio system in response to the generating of the audio signal.

For example, the compare function may comprise a function for comparing the shape and size of the waveforms of the audio signals.

In step 103, the generated audio signal is output in the at least one speaker in the audio system.

For example, the output may comprise a sound such as music, warning signals, test tones etc.

In step 104, the outputted audio signal is received in at least one microphone in the audio system.

In step 105, the received audio signal is transmitted to the compare function in the audio system in response to the receiving of the audio signal.

In step 106, a similarity between the generated and the received audio signal is determined by the compare function.

In some embodiments, a reference system for the audio signals is tuned to generate and receive the audio signals as is without the need for a pre-determined reference system and allowing use of the environment for qualification of the audio system.

In some embodiments, a delay attribute is calculated by a timestamp check based on a timestamp from the generation of the audio signal (reference to step 101) and a timestamp from the reception of the audio signal (reference to step 104).

For example, the similarity between the generated and the received audio signal may be determined by the compare function either by correlation or any other suitable function so that any interference on the received audio signal may be detected.

Further, the correlation may comprise a determined similarity between the shape and size of the wave forms of the generated and the received audio signals.

In step 107, a confidence level is set on the determined similarity based on a current operational mode of the vehicle.

Alternatively or additionally, the operational mode of the vehicle may be indicative of a corresponding correlation impact.

In some embodiments, the current operational mode of the vehicle may be determined.

For example, the operational mode of the vehicle may comprise an empty vehicle standing still or a vehicle with a plurality of vehicle occupants that is travelling fast with the windows open etc.

Hence, the correlation impact may differ depending on the operational mode of the vehicle.

In some embodiments, the generated audio signal is transmitted to the compare function after being processed and while being in the digital domain.

In some embodiments, the received audio signal is transmitted to the compare function after being processed and once being in the digital domain.

In some embodiments, the processing comprises sampling of the audio signal.

For example, the sampling converts a sound wave (i.e. a continuous signal) to a sequence of samples (i.e. a discrete-time signal).

Further, the sampling may comprise sampling the audio signal in a sampling rate of 44.1 kHz, 48 kHz, 88.2 kHz, or 96 kHz.

In some embodiments, the compare function determines a similarity between the generated and the received audio signal.

In some embodiments, the audio signal is distinguished from the ambient input at least in its frequency.

For example, ambient input may comprise the audio input generated by a plurality of vehicle occupants, the audio input created by the vehicle at high speeds, the audio input created by the air flow in the vehicle when the windows are opened etc.

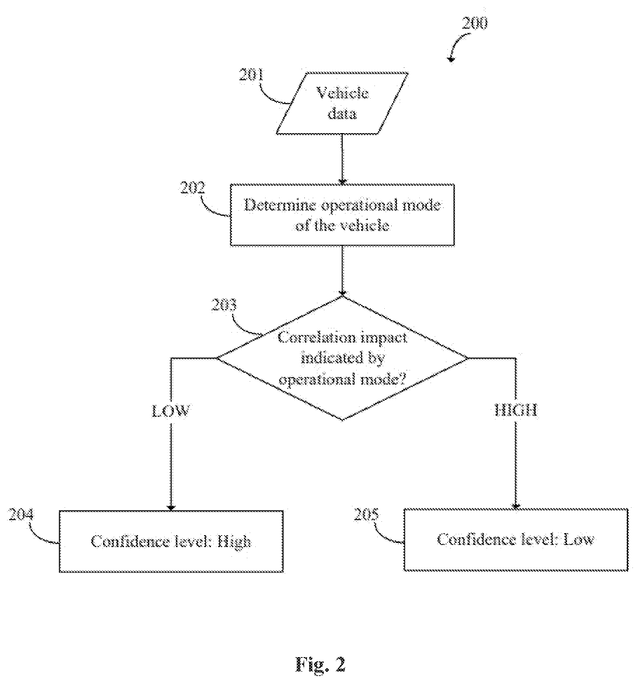

FIG. 2 is a flowchart illustrating example method steps according to some embodiments. The audio diagnostics method 200 is for diagnosing an audio system in a vehicle. Thus, the method 200 may, for example, be performed by the audio diagnostics system 300 of FIG. 3.

In step 201, vehicle data of a current operational mode of the vehicle is made available.

In step 202, the current operational mode of the vehicle is determined.

In some embodiments, the current operational mode of the vehicle is based on input received from at least one sensor in the vehicle.

For example, the at least one sensor may comprise any one of a speed detection sensor, a seat occupation sensor, and a window state sensor.

In step 203, a correlation impact is indicated based on the operational mode of the vehicle.

In step 204, the correlation impact is determined to be low (i.e. a low impact on the correlation) and therefore a confidence level of the correlation is determined to be High.

For example, the low impact on the correlation may comprise an empty vehicle standing still and wherein the audio signals in this environment are deemed to have a high confidence level.

In step 205, the correlation impact is determined to be high (i.e. a high impact on the correlation) and therefore a confidence level of the correlation is determined to be Low.

For example, the high impact on the correlation may comprise a vehicle with a plurality of vehicle occupants that is travelling fast with the windows open and wherein the audio signals in this environment are deemed to have a low confidence level.

Other confidence levels than high and low are possible and are definable based on the correlation impact in the audio system. For example, a more extensive range in confidence levels of 1-5 is possible e.g. a No impact (Very High confidence level), a Low impact (High confidence level), a Medium impact (Medium confidence level), a High impact (Low confidence level) and a Very High Impact (Very Low confidence level) etc.

FIG. 3 is a schematic overview illustrating an example audio diagnostics system according to some embodiments. The audio diagnostics system 300 is for diagnosing an audio system in a vehicle. Thus, the system 300 may, for example, perform the methods steps of the audio diagnostics methods 100 of FIG. 1 and 200 of FIG. 2.

The audio diagnostics system 300 comprises an apparatus for diagnosing an audio system in a vehicle. The apparatus comprises a memory comprising executable instructions, one or more processors configured to communicate with the memory wherein the one or more processors are configured to cause the apparatus to generate an audio signal of a particular frequency for at least one speaker 304, 305 in the audio diagnostics system 300, transmit the generated audio signal to a compare function (not shown) in the audio diagnostics system 300 in response to the generating of the audio signal, output the generated audio signal 306 in the at least one speaker 304, 305 in the audio diagnostics system 300, receive the outputted audio signal 306, 307 in at least one microphone 302, 303 in the audio diagnostics system, transmit the received audio signal 307 to the compare function in the audio diagnostics system 300 in response to the receiving of the audio signal, determine by the compare function a similarity between the generated 306 and the received audio signal 307, and set a confidence level on the determined similarity based on a current operational mode of the vehicle 301.

In some embodiments, the one or more processors may be configured to cause the apparatus to determine the current operational mode of the vehicle.

In some embodiments, the compare function may be configured to cause the apparatus determine a similarity between the generated and the received audio signal (either by correlation or any other suitable function).

The audio diagnostics system 300 comprising the apparatus for diagnosing an audio system may be further comprised in a vehicle 301.

For example, the operational mode of the vehicle 301 may be determined by inputs received from sensors in the vehicle e.g. a speed detection sensor, a seat occupation sensor, and a window state sensor.

For example, the speed detection sensor may detect that the vehicle has a speed of 0 km/h, no detected vehicle occupants seated, and the windows of the vehicle closed. Hence, the operational mode of the vehicle 301 may indicate an empty vehicle standing still.

For example, the speed detection sensor may detect that the vehicle has a speed of 90 km/h, two detected vehicle occupants seated, and the windows of the vehicle opened. Hence, the operational mode of the vehicle 301 may indicate a vehicle comprising a plurality of vehicle occupants, travelling fast with the windows open.

FIG. 4 is a schematic block diagram illustrating an example arrangement according to some embodiments. The example arrangement is an audio diagnostics arrangement 400 for diagnosing an audio system in a vehicle, wherein the arrangement is configured to be associated with speaker arrangement SPK 450, e.g. speaker circuitry, microphone arrangement MIC 440, e.g. microphone circuitry, and compare arrangement COMP 420, e.g. compare circuitry.

The audio diagnostics arrangement 400 comprises a generating arrangement GEN 401, e.g. generating circuitry, configured to generate an audio signal of a particular frequency for at least one speaker in the audio system, a transmitting arrangement TX/RX 430, e.g. transmitting circuitry, configured to transmit the generated audio signal to a compare function in the audio system in response to the generating of the audio signal, an outputting arrangement OUT 402, e.g. outputting circuitry, configured to output the generated audio signal in the at least one speaker in the audio system, a receiving arrangement REC 403, e.g. receiving circuitry, configured to receive the outputted audio signal in at least one microphone in the audio system, a transmitting arrangement TX/RX 430, e.g. transmitting circuitry, configured to transmit the received audio signal to the compare function in the audio system in response to the receiving of the audio signal, a receiving arrangement DET 404, e.g. determining circuitry, configured to determine a similarity between the generated and the received audio signal, and a setting arrangement SET 405, e.g. setting circuitry, configured to set a confidence level on the determined similarity based on a current operational mode of the vehicle.

The audio diagnostics arrangement 400 may be comprised in the audio diagnostics system 300 described in connection with FIG. 3 and/or the audio diagnostics arrangement 400 may be configured to perform method steps of any of the methods described in connection with FIGS. 1 and 2.

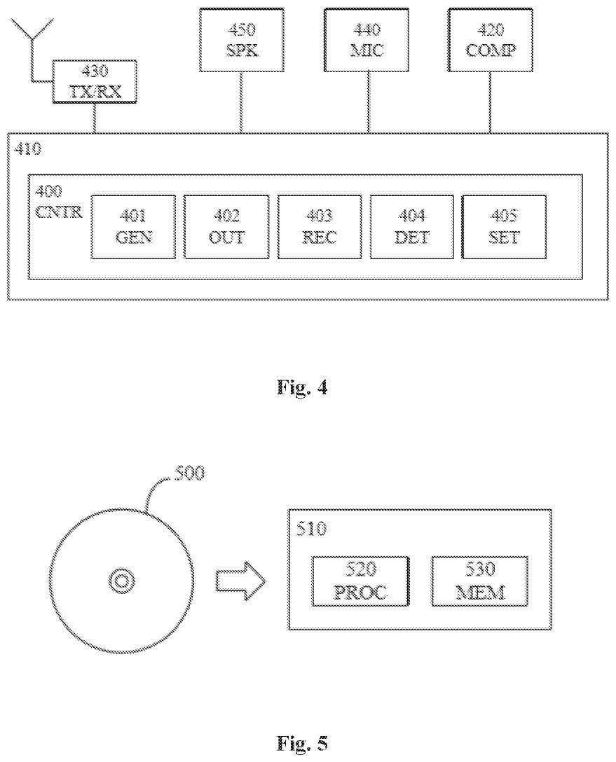

FIG. 5 is a schematic drawing illustrating an example computer readable medium according to some embodiments. The computer program product comprises a non-transitory computer readable medium 500 having thereon a computer program 510 comprising program instructions, wherein the computer program being loadable into a data processing unit and configured to cause execution of the method steps of any of the methods described in connection with FIGS. 1 and 2.

Generally, when an arrangement is referred to herein, it is to be understood as a physical product; e.g., an apparatus. The physical product may comprise one or more parts, such as controlling circuitry in the form of one or more controllers, one or more processors, or the like.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a vehicle.

Embodiments may appear within an electronic apparatus (associated with or comprised in a vehicle) comprising arrangements, circuitry, and/or logic according to any of the embodiments described herein. Alternatively or additionally, an electronic apparatus (associated with or comprised in a vehicle) may be configured to perform methods according to any of the embodiments described herein.

According to some embodiments, a computer program product comprises a computer readable medium such as, for example a universal serial bus (USB) memory, a plug-in card, an embedded drive or a read only memory (ROM). FIG. 5 illustrates an example computer readable medium in the form of a compact disc (CD) ROM 500. The computer readable medium has stored thereon a computer program comprising program instructions. The computer program is loadable into a data processor (PROC) 520, which may, for example, be comprised in a vehicle 510. When loaded into the data processing unit, the computer program may be stored in a memory (MEM) 530 associated with or comprised in the data-processing unit. According to some embodiments, the computer program may, when loaded into and run by the data processing unit, cause execution of method steps according to, for example, any of the methods illustrated in FIGS. 1 and 2 or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

What is claimed is:

1. A method for diagnosing an audio system in a vehicle, comprising the steps of:
generating an audio signal of a particular frequency for at least one speaker in the audio system,
transmitting the generated audio signal to a compare function in the audio system in response to the generating of the audio signal,
outputting the generated audio signal in the at least one speaker in the audio system,
receiving the outputted audio signal in at least one microphone in the audio system,
transmitting the received audio signal to the compare function in the audio system in response to the receiving of the audio signal,
determining by the compare function a similarity between the generated and the received audio signal, and
setting a confidence level on the determined similarity based on a current operational mode of the vehicle.

2. The method according to claim 1, further comprising:
determining the current operational mode of the vehicle.

3. The method according to claim 1, wherein the generated audio signal is transmitted to the compare function after being processed and while being in the digital domain.

4. The method according to claim 1, wherein the received audio signal is transmitted to the compare function after being processed and once being in the digital domain.

5. The method according to claim 1, wherein the processing comprises sampling of the audio signal.

6. The method according to claim 1, wherein the compare function determines a similarity between the generated and the received audio signal.

7. The method according to claim 1, wherein the audio signal is distinguished from the ambient input at least in its frequency.

8. The method according to claim 1, wherein the current operational mode of the vehicle is based on an input received from at least one sensor in the vehicle.

9. The method according to claim 8, wherein the confidence level is set to high when the input is indicative of a low impact on correlation.

10. The method according to claim 8, wherein the confidence level is set to low when the input is indicative of a high impact on the correlation.

11. The method according to claim 8, wherein the at least one sensor in the vehicle comprises any one of a speed detection sensor, a seat occupation sensor, and a window state sensor.

12. A non-transitory computer readable medium, having stored thereon a computer program comprising program instructions, the computer program being loadable into a data processing unit and configured to cause execution of the method according to claim 1 when the computer program is run by the data processing unit.

13. An apparatus for diagnosing an audio system in a vehicle, comprising:
a memory comprising executable instructions,
one or more processors configured to communicate with the memory wherein the one or more processors are configured to cause the apparatus to:
generate an audio signal of a particular frequency for at least one speaker in the audio system,
transmit the generated audio signal to a compare function in the audio system in response to the generating of the audio signal,
output the generated audio signal in the at least one speaker in the audio system,
receive the outputted audio signal in at least one microphone in the audio system,
transmit the received audio signal to the compare function in the audio system in response to the receiving of the audio signal,
determine by the compare function a similarity between the generated and the received audio signal, and
set a confidence level on the determined similarity based on a current operational mode of the vehicle.

14. The apparatus according to claim 13, wherein the one or more processors are configured to cause the apparatus to determine the current operational mode of the vehicle.

15. The apparatus according to claim 13, wherein the one or more processors are configured to cause the apparatus to perform a compare function for determining a similarity between the generated and the received audio signal.

16. A vehicle comprising the apparatus according to claim 13.

17. A system for diagnosing an audio system in a vehicle, comprising:
a generating module configured to generate an audio signal of a particular frequency for at least one speaker in the audio system,
a transmitting module configured to transmit the generated audio signal to a compare function in the audio system in response to the generating of the audio signal,
an outputting module configured to output the generated audio signal in the at least one speaker in the audio system,
a receiving module configured to receive the outputted audio signal in at least one microphone in the audio system,
a transmitting module configured to transmit the received audio signal to the compare function in the audio system in response to the receiving of the audio signal,
a determining module configured to determine a similarity between the generated and the received audio signal, and
a setting module configured to set a confidence level on the determined similarity based on a current operational mode of the vehicle.

18. A system according to claim 17, further comprising:
a determining module configured to determine the current operational mode of the vehicle.

19. A system according to claim 17, further comprising:
a compare function module configured to determine a similarity between the generated and the received audio signal.
